(19) United States
(12) Patent Application Publication
(10) Pub. No.: US 2012/0163209 A1
(43) Pub. Date: Jun. 28, 2012

(54) APPARATUS AND METHOD FOR ANALYZING NETWORK PACKETS BASED ON HISTORY

(75) Inventor: Hang-Kee KIM, Daejeon (KR)

(73) Assignee: Electronics and Telecommunications Reseach Institute, Daejeon-city (KR)

(21) Appl. No.: 13/300,243

(22) Filed: Nov. 18, 2011

(30) Foreign Application Priority Data
Dec. 22, 2010 (KR) 10-2010-0132865

(51) Int. Cl. H04L 12/26

(52) U.S. Cl. 370/252

(57) ABSTRACT

Disclosed herein is a network packet analysis technology that analyzes packet protocols without having preliminary information about the sequence of network packets, and is capable of analyzing the meanings of fields of each network packet, as well as the temporal sequence of the network packets, using pre-stored history sets. For this, the apparatus for analyzing network packets includes a history set generation unit for capturing and synchronizing network packets, input events and screen shots when an application is running, and then generating a plurality of history sets. A history set storage unit stores the plurality of history sets. A packet analysis unit analyzes the plurality of history sets stored in the history set storage unit and then analyzes a temporal sequence of the network packets and individual fields of each network packet.

### CROSS REFERENCE TO RELATED APPLICATION

This application claims the benefit of Korean Patent Application No. 10-2010-0132865, filed on Dec. 22, 2010, which is hereby incorporated by reference in its entirety into this application.

### BACKGROUND OF THE INVENTION

1. Technical Field

The present invention relates generally to an apparatus and method for analyzing network packets based on history. More particularly, the present invention relates to an apparatus and method for analyzing network packets based on history, which can analyze a packet protocol without having preliminary information about the sequence of network packets and can analyze the meanings of the fields of each network packet as well as the temporal sequence of the network packets by using pre-stored history sets.

2. Description of the Related Art

When information about a packet protocol is known in remote network communication, relevant networks can be easily combined, processed and regenerated. However, in many cases, the packet protocol is not known or, even if the packet protocol is known, only a part of it is. In particular, when a user generates and uses his or her own specific network protocol depending on a relevant application, a third party cannot access a relevant network. Therefore, it is impossible to provide Quality Assurance (QA) services such as the analysis of the performance of a relevant network or server or error tracking for the network or server. Here, the term “application” denotes a software application program running on digital hardware (for example, a Personal Computer (PC), a game console, a smartphone, or the like).

When it is desired to provide network QA services from the outside of the network without having the protocol information, the execution of the QA service is possible only when even a part of the protocol information must be analyzed.

### SUMMARY OF THE INVENTION

Accordingly, the present invention has been made keeping in mind the above problems occurring in the prior art, and an object of the present invention is to analyze a packet protocol without having preliminary information about the sequence of network packets.

Another object of the present invention is to analyze the meanings of fields of each network packet, as well as the temporal sequence of network packets, using pre-stored history sets.

A further object of the present invention is to improve the precision of packet analysis by repeatedly executing an application several times and comparing and analyzing history sets obtained during the repeated execution.

Yet another object of the present invention is to easily detect errors that may occur in a desired network packet sequence or in the field values of network packets.

In accordance with an aspect of the present invention to accomplish the above objects, there is provided an apparatus for analyzing network packets, including a history set generation unit for capturing and synchronizing network packets, input events and screen shots when an application is running, and then generating a plurality of history sets; a history set storage unit for storing the plurality of history sets; and a packet analysis unit for analyzing the plurality of history sets stored in the history set storage unit and then analyzing a temporal sequence of the network packets and individual fields of each network packet.

Preferably, the apparatus may further include a re-execution unit for allowing the history set generation unit to generate a plurality of additional history sets by re-executing the application, and for storing the plurality of additional history sets in the history set storage unit so that the additional history sets correspond to the plurality of history sets.

Preferably, the re-execution unit may be configured such that each of the input events for the plurality of history sets stored in the history set storage unit is received and then the application is re-executed.

Preferably, the packet analysis unit may be configured such that a predetermined history set of the plurality of history sets is compared with a predetermined additional history set of the plurality of additional history sets, which corresponds to the predetermined history set, and if network packets having an identical form are exchanged when each of the input events is received, the predetermined history set is defined as a representative history set, and then a temporal sequence of the network packets is analyzed.

Preferably, the history set generation unit may include a network packet capture unit for capturing the network packets when the application is running; an input event capture unit for capturing the input events produced by a user when the application is running; a screen shot capture unit for capturing the screen shots when the application is running; and a synchronization unit for synchronizing the network packets, the input events and the screen shots with one another.

Preferably, the packet analysis unit may include a sequence analysis unit for analyzing the plurality of history sets and then analyzing a temporal sequence of the network packets exchanged by the application when each of the input events is received; and a field analysis unit for analyzing a screen shot appearing when the input event is received, searching the screen shot for a relevant data value, searching the network packets for the relevant data value, and analyzing individual fields of each of the network packets.

Preferably, each input event may be generated when absolute screen coordinates, or coordinates relative to previous coordinates, are captured.

Preferably, each input event may be obtained by at least one of a mouse, a keyboard, a touch screen, a joypad, and a Gravity (G) sensor.

Preferably, the screen shots may be still shots or videos corresponding to the network packets and the input events.

In accordance with another aspect of the present invention to accomplish the above objects, there is provided a method of capturing network packets, including capturing and synchronizing network packets, input events and screen shots when an application is running, and then generating a plurality of history sets; storing the plurality of history sets; and analyzing the plurality of history sets and then analyzing a temporal sequence of the network packets and individual fields of each network packet.

Preferably, the method may further include re-executing the application, and capturing and synchronizing network packets, input events and screen shots of the re-executed application, thus generating a plurality of additional history sets; and storing the plurality of additional history sets.

Preferably, the generating the plurality of additional history sets may be configured such that such that each of the input events for the plurality of history sets stored in the history set storage unit is received and then the application is re-executed.

Preferably, the analyzing the temporal sequence of the network packets and individual fields of each network packet may be configured such that a predetermined history set of the plurality of history sets is compared with a predetermined additional history set of the plurality of additional history sets, which corresponds to the predetermined history set, and if network packets having an identical form are exchanged when each of the input events is received, the predetermined history set is defined as a representative history set, and then the temporal sequence of the network packets is analyzed.

Preferably, the generating the plurality of history sets may include capturing the network packets, the screen shots and the input events produced by the user when the application is running; and synchronizing the network packets, the input events and the screen shots with one another.

Preferably, the temporal sequence of the network packets may be analyzed by analyzing the plurality of history sets and then detecting a temporal sequence of the network packets exchanged by the application when each of the input events is received.

Preferably, the individual fields of each network packet may be analyzed by analyzing a screen shot appearing when each of the input events is received, searching the screen shot for a relevant data value, searching the network packets for the relevant data value, and detecting individual fields of each of the network packets.

Preferably, each input event may be generated when absolute screen coordinates, or coordinates relative to previous coordinates, are captured.

Preferably, each input event may be obtained by at least one of a mouse, a keyboard, a touch screen, a joypad, and a Gravity (G) sensor.

Preferably, the screen shots may be still shots or videos corresponding to the network packets and the input events.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of an apparatus for analyzing network packets according to the present invention;

FIG. 2 is a diagram showing an example of history sets in the network packet analysis apparatus according to the present invention;

FIG. 3 is a flowchart showing a method of analyzing network packets according to the present invention;

FIG. 4 is a flowchart showing a method of generating history sets in the network packet analysis method according to the present invention; and

FIG. 5 is a flowchart showing packet analysis performed in the network packet analysis method according to the present invention.

### DESCRIPTION OF THE PREFERRED EMBODIMENTS

Reference now should be made to the drawings, in which the same reference numerals are used throughout the different drawings to designate the same or similar components.

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, the construction and operation of an apparatus for analyzing network packets according to the present invention will be described with reference to the attached drawings.

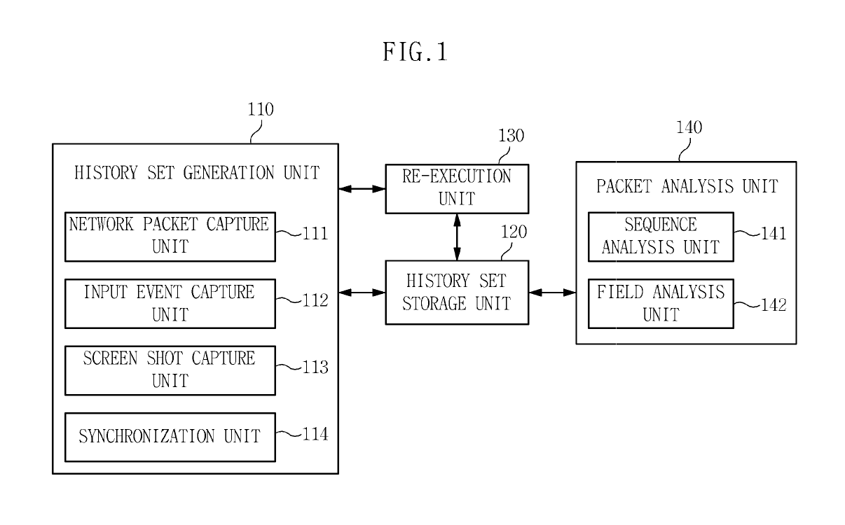

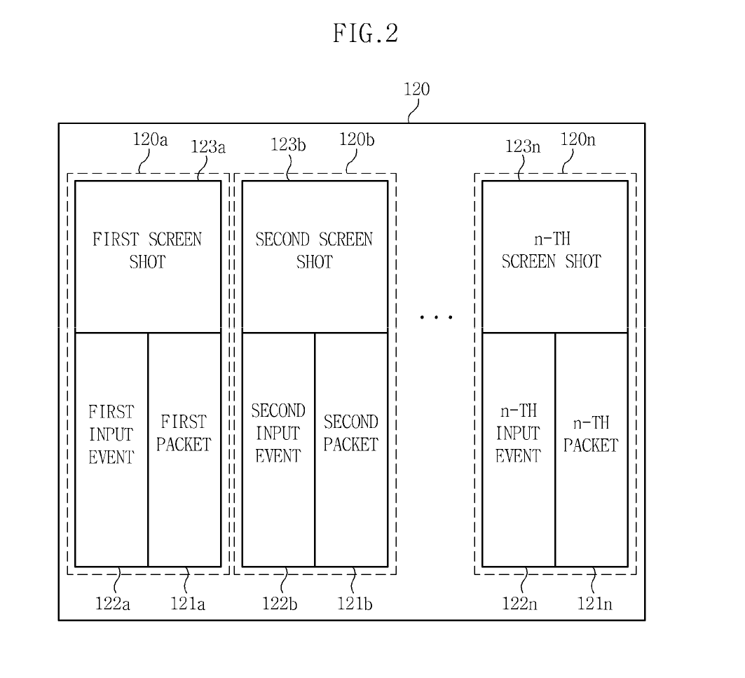

FIG. 1 is a block diagram showing the construction of an apparatus for analyzing network packets according to the present invention. FIG. 2 is a diagram showing an example of history sets in the network packet analysis apparatus according to the present invention.

Referring to FIG. 1, an apparatus 100 for analyzing network packets according to the present invention includes a history set generation unit 110, a history set storage unit 120, and a packet analysis unit 140. The network packet analysis apparatus 100 according to the present invention may further include a re-execution unit 130.

The history set generation unit 110 generates a plurality of history sets by capturing and synchronizing network packets, input events and screen shots. Such a history set generation unit 110 includes a network packet capture unit 111, an input event capture unit 112, a screen shot capture unit 113, and a synchronization unit 114.

The network packet capture unit 111 captures network packets when an application is running. The input event capture unit 112 captures input events produced by a user when the application is running. In this case, the input events may be input data obtained by at least one of a mouse, a keyboard, a touch screen, a joypad, and a Gravity (G) sensor. Further, the input events may be generated when absolute screen coordinates, or coordinates relative to previous coordinates, are captured. The screen shot capture unit 113 captures the input events produced by the user when the application is running. In this case, the screen shots may be still shots or videos corresponding to the network packets and the input events. The synchronization unit 114 ultimately generates a plurality of history sets by synchronizing the network packets, the input events, and the screen shots.

The history set storage unit 120 stores the plurality of history sets generated by the history set generation unit 110.

The re-execution unit 130 allows the history set generation unit 110 to generate a plurality of additional history sets by re-executing the application. Further, the re-execution unit 130 stores the plurality of additional history sets in the history set storage unit 120 so that the additional history sets correspond to the plurality of history sets previously generated by the history set generation unit 110. Furthermore, the re-execution unit 130 may re-execute the application by receiving the input events of the plurality of history sets stored in the history set storage unit 120. In other words, the re-execution unit 130 may utilize the input events that were previously captured so as to facilitate the re-execution of the application that is repeatedly implemented several times.

For example, when the state in which a left direction key (←) is pressed at one-second intervals is stored as an input event in the application, software for the input event in which the left direction key (←) is pressed may be generated, and then be transferred to the application. The application perceives it as if the left direction key (←) were actually input, and performs the function corresponding to the case of the left direction key (←) having been pressed.

The packet analysis unit 140 analyzes the temporal sequence of the network packets and the individual fields of each network packet. Further, the packet analysis unit 140 compares network packets captured for the same input event with one another. Furthermore, the packet analysis unit 140 compares a predetermined history set of the plurality of history sets with a predetermined additional history set of the plurality of additional history sets that are generated by the re-execution of the application, wherein the predetermined additional history set corresponds to the predetermined history set. When network packets having the same forms are exchanged in the case where an input event is received in the predetermined history set and the predetermined additional history set, the packet analysis unit 140 may define the predetermined history set as a representative history set. Such a packet analysis unit 140 includes a sequence analysis unit 141 and a field analysis unit 142.

The sequence analysis unit 141 analyzes the plurality of history sets, and then analyzes the temporal sequence of network packets that are exchanged by the application when the input event is received. That is, the sequence analysis unit 141 analyzes a packet sequence. In this case, the packet sequence denotes the arrangement of network packets, exchanged by the application when a specific input event is received, in a temporal sequence.

Hereinafter, it is assumed that a plurality of history sets for the same input event have been acquired during the repeated execution of an application.

If it is assumed that when the same input event is received in a plurality of history sets, packets having the same form are exchanged, the sequence analysis unit 141 analyzes the packets for the relevant input event to have a packet sequence (order) that is fixedly defined.

For example, if the packets are continuously exchanged in the sequence such as that of sending A→receiving B→sending C when the left direction key (←) is pressed several times, the sequence of packets obtained when the left direction key (←) is pressed is analyzed to be “sending A→receiving B→sending C”.

In contrast to this assumption, in the case where packets having different forms are exchanged although the same input event is received in the plurality of history sets, the packet of the most representative history set of the plurality of history sets is selected, and the sequence of packets is analyzed based on the selected packet.

A method of selecting the most representative history set may be implemented using a method of selecting a history set having a minimum difference with respect to other history sets from among the plurality of history sets. A method of comparing differences between history sets may be implemented using a Longest Common Subsequence (LCS) problem solving method for obtaining an edit-distance, a Shortest Edit Path (SES) method, or the like, but the present invention is not limited to such a method.

The method of comparing and analyzing the most representative history set with the remaining history sets is configured to detect an identical part and a different part from among the packets of the representative history set and the remaining history sets. Further, in order to search the different part for an actually meaningful portion, a portion of the different part is applied to the representative history set, and then an attempt is made to actually transmit a resulting network packet to the server. When a desired operation is performed, such a newly applied network packet is used as a representative packet of the representative history set. However, when errors occur, the network packet newly applied as the different part is an erroneous packet, and thus the existing representative history set is maintained.

The field analysis unit 142 analyzes a screen shot appearing when each input event is received, searches the screen shot for a relevant data value, searches network packets for the relevant data value, and then analyzes the individual fields of each network packet.

For example, it is assumed that information about the location (x=367, y=283) of a specific object is present on a given screen. Further, the value corresponding to 367 is searched for in a packet, and a relevant field becomes a value indicative of x when searching is successful. Further, the value corresponding to 283 is searched for in the packet, and a relevant field becomes a value indicative of y when searching is successful.

Referring to FIG. 2, an example of the plurality of history sets stored in the history set storage unit 120 is illustrated. That is, the history set storage unit 120 may store a first history set 120a composed of a first packet 121a, a first input event 122a and a first screen shot 123a that are synchronized with one another. Further, the history set storage unit 120 may store a second history set 120b composed of a second packet 121b, a second input event 122b, and a second screen shot 123b that are synchronized with one another. Furthermore, the history set storage unit 130 may include an n-th history set 120n composed of an n-th packet 121n, an n-th input event 122n, and an n-th screen shot 123n that are synchronized with one another. In this case, the first history set 120a, the second history set 120b, . . . , the n-th history set 120n may be history sets generated by the same input event. That is, the first input event 122a, the second input event 122b, . . . , the n-th input event 122n may be input events produced by the same behavior of the user. In this case, the packet analysis unit 140 may select a representative history set from among the first history set 120a, the second history set 120b, . . . , the n-th history set 120n, and compare the representative history set with the remaining history sets, thus analyzing a packet sequence.

Hereinafter, a method of analyzing network packets according to the present invention will be described.

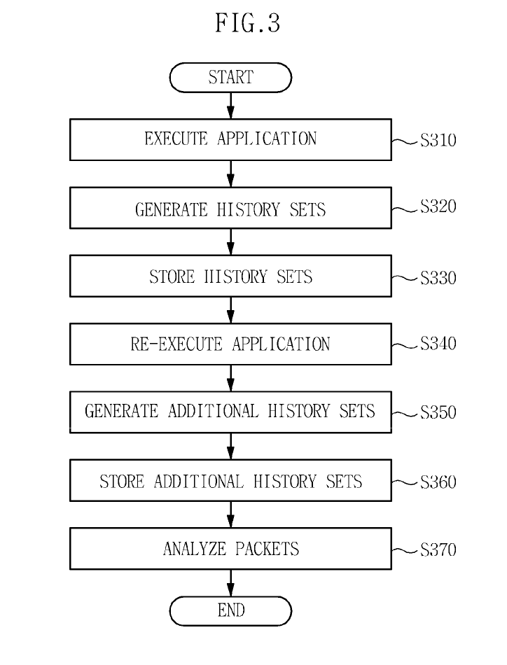

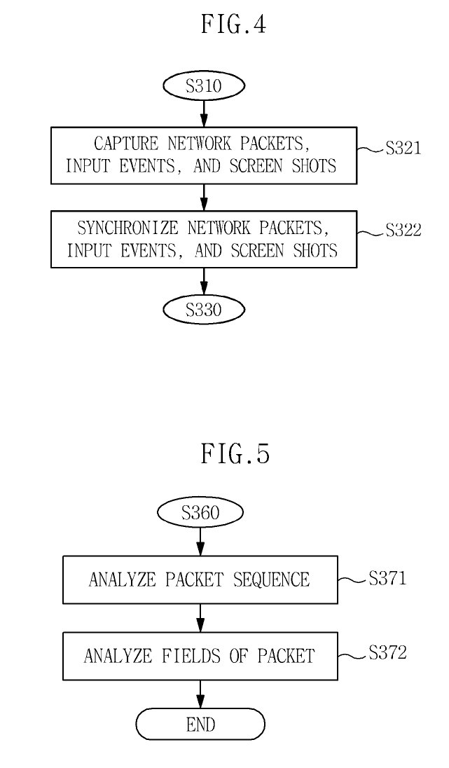

FIG. 3 is a flowchart showing a method of analyzing network packets according to the present invention. FIG. 4 is a flowchart showing a method of generating history sets in the network packet analysis method according to the present invention. FIG. 5 is a flowchart showing packet analysis performed in the network packet analysis method according to the present invention.

Referring to FIG. 3, in the network packet analysis method of the present invention, an application which is a target for network packets is executed at step S310.

Further, network packets, input events and screen shots, appearing when the application is running, are captured and synchronized with one another, and then a plurality of history sets are generated at step S320. Referring to step S320 together with FIG. 4, step S320 may include the step S321 of capturing the network packets, the screen shots, and the input events produced by the user when the application is running, and the step S322 of synchronizing the network packets, the input events and the screen shots with one another. In this case, the input events may be generated when absolute screen coordinates, or coordinates relative to previous coordinates, are captured. Further, the input events may be input data obtained by at least one of a mouse, a keyboard, a touch screen, a joypad, and a G sensor. Further, the screen shots may be still shots or videos corresponding to the network packets and the input events.

Further, the history sets generated at step S320 are stored at step S330.

Furthermore, in order to generate additional history sets, the application is re-executed at step S340. In this case, the application may be re-executed by receiving the input events in the plurality of history sets using software.

Further, network packets, input events and screen shots are captured from the application that is re-executed at step S340, and are synchronized with one another, and thus a plurality of additional history sets are generated at step S350.

The additional history sets generated at step S350 are stored at step S360.

Further, the plurality of history sets are analyzed, so that the temporal sequence of the network packets and the individual fields of each network packet are analyzed at step S370. In this case, the plurality of history sets are compared with the plurality of additional history sets, so that the temporal sequence of the network packets and the individual fields of each network packet can be analyzed. That is, a predetermined history set of the plurality of history sets is compared with a predetermined additional history set of the plurality of additional history sets, which corresponds to the predetermined history set. Further, when network packets having the same form are exchanged in the case where the same input event was received in both the predetermined history set and the predetermined additional history set, the predetermined history set may be defined as a representative history set, and then the temporal sequence of the network packets may be analyzed.

Further, referring to step S370 together with FIG. 5, step S370 may include the step S371 of analyzing the plurality of history sets, and then detecting and analyzing the temporal sequence of network packets that are exchanged by the application when each input event is received, and the step S372 of analyzing a screen shot appearing when the input event is received, searching the screen shot for a relevant data value, searching the network packets for the relevant data value, and then detecting and analyzing the individual fields of each network packet.

As described above, the apparatus and method for analyzing network packets based on history according to the present invention are not limitedly applied by the construction and methods of the above-described embodiments, and all or part of the individual embodiments may be selectively combined and configured so that various modifications are possible.

According to the present invention, a packet protocol can be analyzed without having preliminary information about the sequence of network packets. Therefore, the present invention can transmit over a network the desired functions of an application in the correct sequence.

Further, the present invention enables the meanings of fields of each network packet, as well as the temporal sequence of network packets, to be analyzed using pre-stored history sets.

Furthermore, the present invention updates history sets by repeatedly executing an application several times, and comparing and analyzing history sets obtained during the repeated execution, thus improving the precision of packet analysis.

Furthermore, since the present invention repeatedly executes an application by utilizing an input event for the pre-stored history sets, the history sets can be easily obtained.

Furthermore, the present invention enables a virtual application imitating a specific application to be created because information about network packets exchanged by the specific application can be known.

Furthermore, the present invention enables errors to be easily detected when errors are present in a desired network packet sequence or the field values of a network packet.

What is claimed is:

1. An apparatus for analyzing network packets, comprising:
a history set generation unit for capturing and synchronizing network packets, input events and screen shots when an application is running, and then generating a plurality of history sets;
a history set storage unit for storing the plurality of history sets; and
a packet analysis unit for analyzing the plurality of history sets stored in the history set storage unit and then analyzing a temporal sequence of the network packets and individual fields of each network packet.

2. The apparatus of claim 1, further comprising a re-execution unit for allowing the history set generation unit to generate a plurality of additional history sets by re-executing the application, and for storing the plurality of additional history sets in the history set storage unit so that the additional history sets correspond to the plurality of history sets.

3. The apparatus of claim 2, wherein the re-execution unit is configured such that each of the input events for the plurality of history sets stored in the history set storage unit is received and then the application is re-executed.

4. The apparatus of claim 2, wherein the packet analysis unit is configured such that:
a predetermined history set of the plurality of history sets is compared with a predetermined additional history set of the plurality of additional history sets, which corresponds to the predetermined history set, and
if network packets having an identical form are exchanged when each of the input events is received, the predetermined history set is defined as a representative history set, and then a temporal sequence of the network packets is analyzed.

5. The apparatus of claim 1, wherein the history set generation unit comprises:
a network packet capture unit for capturing the network packets when the application is running;
an input event capture unit for capturing the input events produced by a user when the application is running;
a screen shot capture unit for capturing the screen shots when the application is running; and
a synchronization unit for synchronizing the network packets, the input events and the screen shots with one another.

6. The apparatus of claim 1, wherein the packet analysis unit comprises:
a sequence analysis unit for analyzing the plurality of history sets and then analyzing a temporal sequence of the network packets exchanged by the application when each of the input events is received; and
a field analysis unit for analyzing a screen shot appearing when the input event is received, searching the screen shot for a relevant data value, searching the network packets for the relevant data value, and analyzing individual fields of each of the network packets.

7. The apparatus of claim 1, wherein each input event is generated when absolute screen coordinates, or coordinates relative to previous coordinates, are captured.

8. The apparatus of claim 1, wherein each input event is obtained by at least one of a mouse, a keyboard, a touch screen, a joypad, and a Gravity (G) sensor.

9. The apparatus of claim 1, wherein the screen shots are still shots or videos corresponding to the network packets and the input events.

10. A method of capturing network packets, comprising:
capturing and synchronizing network packets, input events and screen shots when an application is running, and then generating a plurality of history sets;
storing the plurality of history sets; and
analyzing the plurality of history sets and then analyzing a temporal sequence of the network packets and individual fields of each network packet.

11. The method of claim 10, further comprising:
re-executing the application, and capturing and synchronizing network packets, input events and screen shots of the re-executed application, thus generating a plurality of additional history sets; and
storing the plurality of additional history sets.

12. The method of claim 11, wherein the generating the plurality of additional history sets is configured such that each of the input events for the plurality of history sets stored in the history set storage unit is received and then the application is re-executed.

13. The method of claim 11, wherein the analyzing the temporal sequence of the network packets and individual fields of each network packet is configured such that:
a predetermined history set of the plurality of history sets is compared with a predetermined additional history set of the plurality of additional history sets, which corresponds to the predetermined history set, and
if network packets having an identical form are exchanged when each of the input events is received, the predetermined history set is defined as a representative history set, and then the temporal sequence of the network packets is analyzed.

14. The method of claim 10, wherein the generating the plurality of history sets comprises:
capturing the network packets, the screen shots and the input events produced by the user when the application is running; and
synchronizing the network packets, the input events and the screen shots with one another.

15. The method of claim 10, wherein the temporal sequence of the network packets is analyzed by analyzing the plurality of history sets and then detecting a temporal sequence of the network packets exchanged by the application when each of the input events is received.

16. The method of claim 10, wherein the individual fields of each network packet are analyzed by analyzing a screen shot appearing when each of the input events is received, searching the screen shot for a relevant data value, searching the network packets for the relevant data value, and detecting individual fields of each of the network packets.

17. The method of claim 10, wherein each input event is generated when absolute screen coordinates, or coordinates relative to previous coordinates, are captured.

18. The method of claim 10, wherein each input event is obtained by at least one of a mouse, a keyboard, a touch screen, a joypad, and a Gravity (G) sensor.

19. The method of claim 10, wherein the screen shots are still shots or videos corresponding to the network packets and the input events.
